(19) United States
(12) Patent Application Publication
(10) Pub. No.: US 2025/0139610 A1
(43) Pub. Date: May 1, 2025

(54) CARD WITH SURFACE FEATURES FOR ACCOUNT SELECTION

(71) Applicant: VISA INTERNATIONAL SERVICE ASSOCIATION, San Francisco, CA (US)

(72) Inventors: Yuexi Chen, Foster City, CA (US); Simon Hurry, Foster City, CA (US); Pratap Gautam, London (GB); Neil Dickson, London (GB); Philippe Tignol, Paris (FR); Jachin Hoban, London (GB); Andrew Walker, London (GB); Richard Wagstaff, London (GB)

(73) Assignee: VISA INTERNATIONAL SERVICE ASSOCIATION, San Francisco, CA (US)

(21) Appl. No.: 18/689,395

(22) PCT Filed: Sep. 13, 2022
(86) PCT No.: PCT/US2022/043390

§ 371 Date: Mar. 5, 2024

Related U.S. Application Data
(60) Provisional application No. 63/244,162, filed on Sep. 14, 2021.

(51) Int. Cl. G06Q 20/34; G06F 3/044; G06K 19/07; G06K 19/073; G06K 19/077; G06Q 20/20; G06Q 20/22; G06Q 20/40

(52) U.S. Cl. CPC G06Q 20/3572; G06F 3/044; G06K 19/0718; G06K 19/07354; G06K 19/07705; G06Q 20/20; G06Q 20/227; G06Q 20/341; G06Q 20/352; G06Q 20/40145

(57) ABSTRACT

One or more surface features (e.g., capacitive buttons, fingerprint sensor) may be exposed on a surface of a card (e.g., chi payment card). The card may store multiple applications/accounts of a user. The card receives a selection of one of the accounts by the user placing a finger on or pressing on a surface feature associated with the selected account. The card provides credentials associated with the selected account to a terminal. The multi-application card may disable credentials associated with the remaining accounts thereby appearing as a single-application card to the terminal during a transaction.

### CROSS-REFERENCES TO RELATED APPLICATIONS

This application claims benefit under 35 USC § 119 (e) to U.S. Provisional Patent Application No. 63/244, 162 filed Sep. 14, 2021 and entitled “Card With Surface Features For Account Selection”, the disclosure of which is incorporated by reference herein in its entirety for all purposes.

### BACKGROUND

Co-badge payment cards which stores account credentials for multiple payment networks (e.g., associated with multiple payment networks' applications) on the same card. The challenge of a co-badge payment card is the cardholder choice of the application. POS terminals which are already deployed in the field may not be able to support co-badge card applications choice (e.g., not display correctly a payment network application and a choice); ignore a payment network application in favor for another network's application; ignore application priority indicators on the card then always select other network's application first.

If there are multiple payment accounts (e.g., each associated with a different payment application) installed on one payment card, the card shall provide the list of the applications to terminal (e.g., POS) at the beginning of the card terminal interaction, optionally together with priority indicators. Then the logic on the terminal or cardholder interaction on the terminal (e.g., press buttons on terminal to make a list item selection from displayed card applications) decides which card application (e.g., which account) is selected for processing the transaction, which will be next selected by terminal for further card terminal interaction. The drawback of such implementation is the terminals installed in the field are difficult to update, thus the support of new cards which carry new card application which is developed after terminal deployment is difficult. While some card products added a screen, buttons and on card, the structure required a battery to be incorporated in the card, thereby increasing the complexity of the card. The cost of manufacture of such card is 5˜20 times more expensive than the normal chip payment card, the durability of such card is low comparing with normal chip payment card because of extra components on the card. Another drawback of such design is that the cardholder selection on the card using buttons has to be done purposely before the payment transaction, which downgrades the payment user experience. Another drawback of such design is that the battery has to be recharged regularly, or the feature/card stops work when battery is exhausted. In addition, the battery is a chemical, non-environmental friendly component. Moreover, cards usually get bent, and it is of a concern for on-card battery cards as replacing such a card is more costly.

Embodiments address these and other problems, individually and collectively.

### BRIEF SUMMARY

One or more surface features (e.g., capacitive buttons, fingerprint sensor) may be exposed on a surface of a card (e.g., chip payment card). The card may store multiple applications/accounts of a user. The card receives a selection of one of the accounts by the user placing a finger on or pressing on a surface feature associated with the selected account. The card provides credentials associated with the selected account to a terminal. In some embodiments, the multi-application card may disable credentials associated with the remaining accounts thereby appearing as a single-application card to the terminal during a transaction. The card does not include a battery and it is powered up when placed in an operating proximity of the terminal.

Embodiments provide a user card comprising a substrate; an electronic circuit embedded on the substrate; an antenna embedded on the substrate; one or more surface features exposed on a surface of the substrate; and a memory embedded on the substrate electrically coupled to the electronic circuit, the antenna, and the one or more surface features. The memory stores account information associated with a plurality of accounts; and a logic programmed to power up upon entering in a magnetic field of a terminal. The logic is further programmed to determine whether a first surface feature among the one or more surface features is activated. The logic is also programmed to identify, among the plurality of accounts, an account based on determining whether the first surface feature is activated. The logic is programmed to retrieve an account information associated with the identified account. The account information identifies only one of the plurality of accounts. The logic is also programmed to provide the account information to the terminal.

Various embodiments provide a method of manufacturing a user card. The method includes providing a substrate, embedding an electronic circuit on the substrate, and embedding an antenna on the substrate. The method also includes forming one or more surface features exposed on a surface of the substrate, and embedding a memory on the substrate. The method further includes electrically coupling the memory, the electronic circuit, the antenna, and the one or more surface features. The method also includes storing account information associated with a plurality of accounts on the memory. The method further includes storing a logic on the memory. The logic is programmed to power up upon entering in a magnetic field of a terminal. The logic is further programmed to determine whether a first surface feature among the one or more surface features is activated. The logic is also programmed to identify, among the plurality of accounts, an account based on determining whether the first surface feature is activated. The logic is programmed to retrieve an account information associated with the identified account. The account information identifies only one of the plurality of accounts. The logic is also programmed to provide the account information to the terminal.

Various embodiments provide a method comprising powering up, by a logic stored on a memory of a user card, upon entering in a magnetic field of a terminal. Account information associated with a plurality of accounts are stored on the memory. The method further includes determining, by the logic stored on the memory of the user card, whether a first surface feature among one or more surface features exposed on a surface of the user card is activated. The method also includes identifying, among the plurality of accounts, an account based on determining whether the first surface feature is activated. The method further includes retrieving an account information associated with the identified account, wherein the account information identifies only one of the plurality of accounts. The method also includes providing the account information to the terminal.

These and other embodiments are described in further detail below.

### BRIEF DESCRIPTION OF THE DRAWINGS

FIG. 1 shows a diagram of a user card interacting with an access device, according to various embodiments.

FIG. 2 shows an exemplary user card including a fingerprint sensor as an exposed surface feature, according to various embodiments.

FIG. 3 shows an exemplary user card including multiple capacitive buttons as exposed surface features, according to various embodiments.

FIG. 4 illustrates an internal circuit of an exemplary user card with multiple surface features, according to various embodiments.

FIG. 5 illustrates an exemplary user card including multiple exposed surface features, according to various embodiments.

FIG. 6 illustrates a user selecting an account on an exemplary user card using an exposed surface feature, according to various embodiments.

FIG. 7 illustrates various ways a visual aid may be coupled to exposed surface features of a user card, according to various embodiments.

FIG. 8 illustrates multiple user-selectable payment applications stored on a user card, according to various embodiments.

FIG. 9 illustrates initiation and processing of a transaction using a card storing multiple user-selectable payment applications, according to various embodiments.

FIG. 10 illustrates a flowchart of steps, according to various embodiments.

### DETAILED DESCRIPTION

Embodiments provide a user card comprising, a substrate, an electronic circuit embedded on the substrate, an antenna embedded on the substrate, one or more surface features exposed on a surface of the substrate, a memory embedded on the substrate electrically coupled to the electronic circuit, the antenna, and the one or more surface features. The memory stores account information associated with a plurality of accounts; and a logic programmed to: power up upon entering in a magnetic field of a terminal; determine whether a first surface feature among the one or more surface features is activated; identify, among the plurality of accounts, an account based on determining whether the first surface feature is activated; retrieve an account information associated with the identified account, wherein the account information identifies only one of the plurality of accounts; and provide the account information to the terminal.

In some embodiments, the one or more surface features include a fingerprint sensor, wherein the logic is further programmed to acquire a first fingerprint information, wherein the identified account is associated with the first fingerprint information, wherein another account among the plurality of accounts is associated with a second fingerprint information. In other embodiments, the one or more surface features include a capacitive button associated with a first account among the plurality of accounts, wherein the logic is further programmed to determine that the capacitive button is activated by being pressed upon; and identify, among the plurality of accounts, the first account as the identified account based on determining that the capacitive button is activated.

An exemplary user card may include a co-badge payment card. The user card may store account credentials for multiple payment networks (e.g., associated with multiple payment networks' applications) on the same card. Embodiments provide a way for the user to select one of the multiple applications stored on the card by using the exposed surface features provided on the card itself. Accordingly, the user does not have interact with a terminal by, for example, touching the terminal. The user is enabled to make a selection prior to presenting the card to the terminal to initiate the transaction.

Prior to discussing various embodiments, some terms can be described in further detail.

A “user” may include an individual. In some embodiments, a user may be associated with one or more personal accounts and/or payment devices. The user may also be referred to as a cardholder, account holder, or consumer in some embodiments.

A “user card” may be a compact and handheld portable device operated by a user. The user card may be small enough to fit into a wallet, pocket, or purse. The user card may be associated with one or more payment accounts issued by one or more authorizing authorities or issuers. Examples of user cards may include payment cards such as credit cards, smart cards, gift cards, payroll cards, healthcare cards, a discount or loyalty card. An exemplary user card may be associated with a cryptocurrency spending account. A payment device may be used by a user as part of an authentication or authorization process. For example, a user may present a user card to an access device in order to authenticate the user, or a user may present a user card at an access device (e.g., a point of sale (POS) terminal) as part of performing a transaction with a merchant. A user card may possess a user card interface, enabling the payment device to communicate with other devices, such as access devices, point of sale terminals, or enrollment devices. A user card may include a volatile or a non-volatile memory to store information. A user card may possess a biometric device, enabling the payment device to collect biometric information, such as fingerprints or thumbprints. According to various embodiments, a user card may include a co-badged card (e.g., a multi-application card) storing multiple payment applications thereon.

An “access device” may be any suitable device that provides access to a remote system. An access device may also be used for communicating with a resource provider computer, a processing server computer, or any other suitable system. An access device may generally be located in any suitable location, such as at the location of a resource provider or merchant. An access device may be in any suitable form. Some examples of access devices include POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, terminals, and the like. An access device may use any suitable contact or contactless mode of operation to send or receive data from, or associated with, a payment device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a payment device and/or mobile device. Other examples of access devices include devices (e.g., locks, gates, access control boxes, etc.) that control physical access to locations (e.g., venues, transit stations, homes, offices, buildings, etc.), as well as software devices that control access to data or information.

A “resource provider” may be an entity that can provide a resource such as goods, services, information, and/or access. Examples of resource providers includes merchants, data providers, transit agencies, governmental entities, venue and dwelling operators, etc. A resource provider may operate a resource provider computer.

A “merchant” may typically be an entity that engages in transactions and can sell goods or services, or provide access to goods or services.

An “authorizing entity” may be an entity that authorizes a request. Examples of an authorizing entity may be an issuer, a governmental agency, a document repository, an access administrator, etc. An authorizing entity may operate an authorizing entity computer.

An “issuer” may typically refer to a business entity (e.g., a bank) that maintains an account for a user that is associated with a user card. An issuer may also issue account parameters associated with the account. An issuer may be associated with a host system that performs some or all of the functions of the issuer on behalf of the issuer.

A “processing server computer” may include a server computer used for processing transactions from a network. In some embodiments, the processing server computer may be coupled to a database and may include any hardware, software, other logic, or combination of the preceding for servicing the requests from one or more client computers or user devices. The processing server computer may comprise one or more computational apparatuses and may use any of a variety of computing structures, arrangements, and compilations for servicing the requests from one or more client computers or user devices. In some embodiments, the processing server computer may operate multiple server computers. In such embodiments, each server computer may be configured to process a transaction for a given region or handles transactions of a specific type based on transaction data.

The processing server computer may include data processing subsystems, networks, and operations used to support and deliver authorization services, exception file services, and clearing and settlement services. An exemplary processing server computer may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The processing server computer may use any suitable wired or wireless network including the Internet.

The processing server computer may process transaction-related messages (e.g., authorization request messages and authorization response messages) and determine the appropriate destination computer (e.g., issuer computer/authorizing authority computer) for the transaction-related messages. In some embodiments, the processing server computer may authorization transactions on behalf of an issuer. The processing server computer may also handle and/or facilitate the clearing and settlement of financial transactions.

“Authorization processing” or “authorization operations” may include at least determining whether to authorize a transaction. Authorization processing may be executed responsive to receiving a notification that a prior step in a transaction has been completed. Alternatively, or additionally, authorization processing may include generating and sending an authorization request message and/or authorization response message.

“Transaction data” or “transaction details” may refer to information

associated with a transaction. For example, transaction data may include one or more of an authorized amount (e.g., transaction amount, item value, etc.), other amount, terminal country code, terminal verification results, transaction currency code, transaction date, transaction type (e.g., card-present transaction, high value transaction, low value transaction, local transaction, international transaction, etc.), an unpredictable number, application interchange profile (AIP), application transaction counter (ATC), issuer application data (IAD), etc.

The term “message” may include any data or information that may be transported from one entity to another entity (e.g., one computing device to another computing device). Messages may be communicated internally between devices/components within a computer or computing system or externally between devices over a communications network. Additionally, messages may be modified, altered, or otherwise changed to comprise encrypted or anonymized information.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer-readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

Embodiments provide various features that may be applicable to user cards, including co-badged user cards.

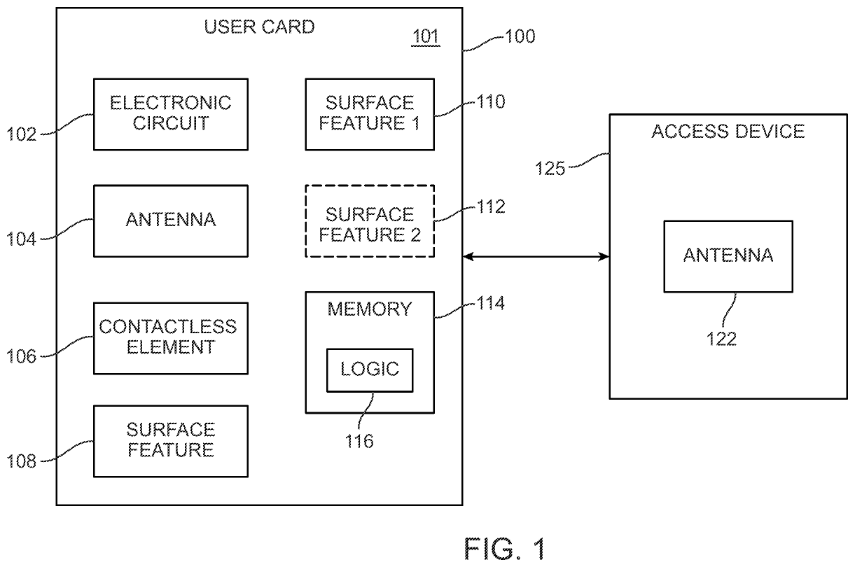

FIG. 1 shows a diagram of a user card interacting with an access device, according to various embodiments. As shown in FIG. 1, a user card 100 may include a substrate 101, an electronic circuit 102 embedded on the substrate 101, an antenna 104 embedded on the substrate 101, a first surface feature 110 exposed on a surface of the substrate 101, and a communication interface such as a contactless element 106. In some embodiments, the user card 100 may include a second surface feature 112 exposed on the surface of the substrate 101. In some embodiments, the first surface feature 110 and the second surface feature 112 may include one or more of a capacitive button that may be pressed upon to activate and/or deactivate certain features of the user card 100, as explained below in greater detail. The user card 100 may also include additional surface features 108, for example elements other than capacitive buttons, such as one or more light emitting diodes (LED), sensors, etc.

The user card 100 may also include a memory 114 embedded on the substrate 101. The memory 114 may be electrically coupled to one or more of the electronic circuit 102, the antenna 104, the contactless element 106, and the one or more surface features 110, 112, 108. According to various embodiments, the memory 114 may also store account information associated with a plurality of accounts. For example, the user card 100 may include a payment card, and the account information may include payment credentials.

According to various embodiments, when the user card 100 is brought in proximity of an access device 125 (e.g., a POS terminal of a merchant), the user card 100 gets powered up. For example, a user may tap the user card 100 on the access device 125 or dip the user card 100 in the access device 125. The access device 125 may include an antenna 122 configured to interact with the user card 100. According to the embodiments, the user card 100 does not have a battery so the user card 100 may need to be tapped or dipped in the access device 125 to get power from the interaction with the access device 125. For example, the user card 100 may power up upon entering in a magnetic field of the access device 125 (e.g., the user card 100 is powered through magnetic induction). The antenna 104 of the user card 100 may act like a coil when the user card 100 is within the electromagnetic field created by the access device 125. Current induced on the antenna 104 by the electromagnetic field may be used to power the electronic circuit 102 connected to the antenna 104. The access device 125 and the user card 100 may be inductively coupled (e.g., magnetically coupled), the access device 125 provides energy to the user card 100. Once powered, the user card 100 starts executing the computer code stored on the memory 114 of the user card 100. Accordingly, the user card 100 is passively powered (e.g., the user card 100 is powered by the interaction with the access device 125).

A logic 116 stored on the memory 114 of the user card 100 may be programmed to power up upon entering in the magnetic field of the access device 125 (e.g., a terminal associated with a resource provider). The logic 116 may be programmed to determine whether a first surface feature 110 among the one or more surface features 110, 112 of the user card 100 is activated. As provided above, the memory 114 may also store account information associated with a plurality of accounts. Each of the surface features 110, 112 may be associated with a different account information. The logic 116 may be programmed to then identify, among the plurality of accounts, an account based on determining whether the first surface feature 110 is activated. The logic 116 may be programmed to retrieve an account information associated with the identified account. The account information identifies only one of the plurality of accounts whose account information is stored on the memory 114. The logic 116 may be programmed to provide the account information to the access device 125. For example, the account information may be provided using a near field communication (NFC) capability of the user card 100.

For example, a first account (and first account information) may be associated with the first surface feature 110 and a second account (and second account information) may be associated with the second surface feature 112. If the first surface feature 110 is activated, the identified account may include the first account. If the second surface feature 112 is activated, the identified account may include the second account. In some embodiments, the logic 116 may be programmed to select a default account (e.g., either the first account, the second account, or a different account may be previously set as the default account; a randomly-selected account) if no surface feature is activated. The logic 116 may determine that no surface feature is activated when no touch is detected on any of the surface features of the user card 100, or touch is detected on more than one surface feature of the user card 100 (e.g., a miss trigger).

In some embodiments, the second account may include a loyalty points account associated with the first account. In other embodiments, the first account or the second account may include a blockchain address for cryptocurrency spending.

That is, instead of informing the access device 125 of the availability or existence of account information associated with two or more accounts on the user card 100, the user card 100 informs the access device 125 of the availability or existence of account information associated with only one account based on the selected surface feature 110, 112. Thus, embodiments allow a co-badged card to act like a regular, single account payment card that does not carry account information associated with more than one account. Accordingly, the selection of the account to be used among the multiple accounts on a co-badged card is trusted to the cardholder, as opposed to the resource provider. The resource provider will not be able to override the cardholder's choice because the resource provider will not be aware that the presented user card is a co-badged card (e.g., a multi-application card).

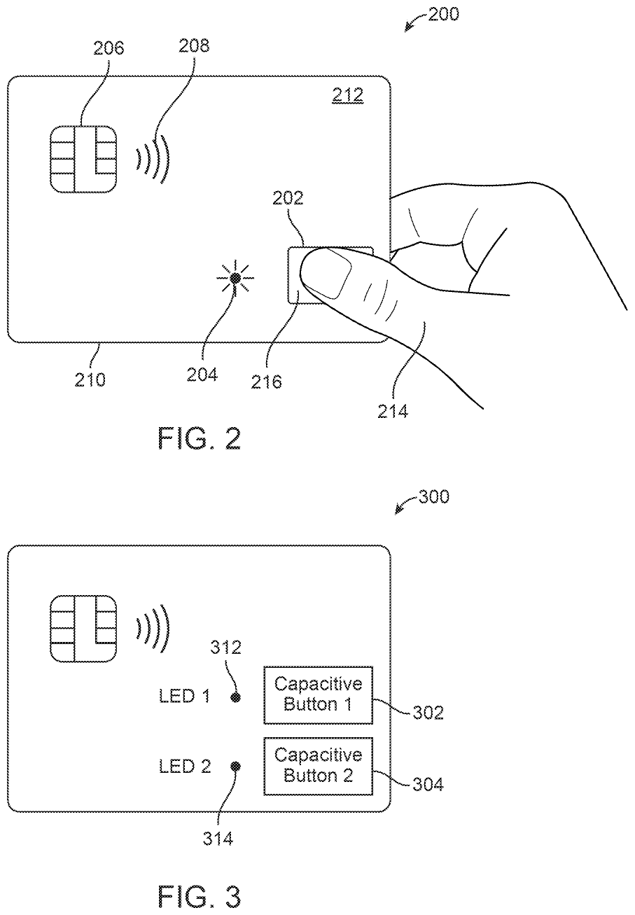

FIG. 2 illustrates an exemplary user card including a fingerprint sensor as an exposed surface feature, according to various embodiments. The user card 200 may include a first surface feature 202 that includes a fingerprint sensor 216.

According to various embodiments, a first account (and first account information) may be associated with a first fingerprint information and a second account (and second account information) may be associated with a second fingerprint information. This information may be stored on the memory of the user card 200. The logic 116 may be further programmed to acquire a fingerprint information when the surface feature 202 is activated (e.g., pressed upon by a finger 214). If the acquired fingerprint is the first fingerprint, the logic 116 may retrieve the first account information associated with the first account. If the acquired fingerprint is the second fingerprint, the logic 116 may retrieve the second account information associated with the second account. First, the logic 116 of the user card 200 may first detect whether there is a finger or not on the surface feature 202. If there is a finger on the surface feature 202, the logic 116 may then detect which finger it is. The outcome may be a first enrolled finger (e.g., right thumb), or second enrolled finger (e.g., right index) or that there is no finger on the surface feature 202. Depending on which finger is on the surface feature 202, the logic 116 may change its contact interface behavior to the access device 125.

According to various embodiments, the user card 100, 200 may also include one or more visual aids 204 exposed on the surface of the substrate. For example, the visual aid 204 may include at least one light emitting diode (LED). The visual aid 204 may be coupled to the user card 200 for account selection in addition to a fingerprint authentication feature. For example, the cardholder may store one or more fingerprints on the user card 200 as associated with one or more accounts. When the cardholder places a finger on the fingerprint sensor 216 during a contact or contactless transaction, the fingerprint sensor 216 captures the fingerprint. The logic on the user card 200 then matches the captured fingerprint against the stored fingerprint templates, identifies the associated account, lights the LED accordingly to the match result. Embodiments further allow the fingerprint to be used to select an account (e.g., a payment application) among two or more accounts (e.g., payment applications) stored on the card.

According to some embodiments, an exemplary co-badged card may store a first payment application (e.g., an international or global payment application associated with a first account) and a second application (e.g., a domestic payment application associated with a second account). The cardholder enrolls two fingerprints onto the co-badged card: a first fingerprint is assigned to the first payment application and a second fingerprint is assigned to the second payment application. A default payment application may be set to either the first payment application or the second payment application. The cardholder puts either finger to the fingerprint sensor of the co-badged card when making a payment during a transaction. The co-badged card captures the fingerprint and matches the captured fingerprint against the first fingerprint template or the second fingerprint template. If match is successful, the logic activates the associated payment application and deactivates the other payment application(s). For example, if matched index is the first fingerprint template, the logic activates the first payment application and deactivates the second payment application. If matched index is the second fingerprint template, the logic activates the second payment application and deactivates the first payment application. If there is no match between the acquired fingerprint and the stored fingerprint templates, the logic may activate a default (e.g., the first) payment application and deactivate other (e.g., the second) payment application. In some embodiments, when there is no match between the acquired fingerprint and the stored fingerprint templates, the logic may deactivate all payment applications. In some embodiments, the visual aid 204 may provide different visual cues depending on the selected payment application. For example, if the visual aid 204 is a LED, the emitted light may appear differently for the first fingerprint template match success (e.g., solid green), the second fingerprint template match success (e.g., flashing green), or match failures (e.g., solid red). This differentiation may serve the purpose of indicating the matching result and application selection result to the cardholder.

In some embodiments, a co-badged card issuer may wish to use the fingerprint match as a cardholder verification mechanism when the cardholder is transacting with the first payment application, and to use other cardholder verification mechanism e.g., online PIN, for the second payment application. The cardholder may enroll the first fingerprint to the co-badged card as associated with the first payment account. If the cardholder wants to select the first application, the cardholder may place the enrolled finger on the fingerprint sensor. If match is successful, the logic activates the first application and notifies the first application of the match result. If the cardholder wants to select the second application, the cardholder may place another finger or no finger on the fingerprint sensor. The match would fail, and the logic will activate the second application.

FIG. 3 shows an exemplary user card including multiple mechanical or capacitive buttons as exposed surface features, according to various embodiments. The user card 300 illustrated in FIG. 3 may include a first capacitive button 302 and a second capacitive button 304 exposedly coupled to a surface of the user card 300. The user card 300 further includes a first visual aid (e.g., a first LED indicator) 312 and a second visual aid (e.g., a second LED indicator) 314. Each one of the visual aids 312, 314 is associated with one of the surface features (e.g., capacitive buttons 302, 304), respectively. That is, the visual aids 312, 314 are provided in proximity of or below the surface feature (e.g., capacitive button 302, 304) associated with the visual aid 312, 314. The visual aids 312, 314 are activated when a corresponding one of the surface features (e.g., capacitive buttons 302, 304) are activated.

In some embodiments, the user card 300 may include a contact only card, contactless only card, or dual interface card. Cardholder can provide user selection on the sensory areas by putting finger(s) over one of the capacitive buttons 302, 304, which may change the card behavior and/or card content for the upcoming transaction. In some embodiments, once the user selects an application by placing a finger over one of the capacitive buttons 302, 304, the logic on the user card 300 is programmed to activate the payment application associated with the pressed capacitive button, and de-activate the payment application(s) associate with the non-selected capacitive button(s). Therefore, the user card 300 may appear as a single-payment-application card to the access device (e.g., POS terminal). When the access device reads data from the user card 300, only data associated with the selected payment application will be available to the access device. Therefore, the access device is not capable of overriding the user choice using an alternate payment application stored on the user card 300.

According to an exemplary embodiment, the first capacitive button 302 may be associated with a first account (e.g., a first payment application) and the second capacitive button 304 may be associated with a second account (e.g., a second payment application). The user card 300 may include a logic programmed to determine that the first capacitive button is activated by being pressed upon. The logic may then identify among the plurality of accounts, the first account as the identified account based on determining that the capacitive button is activated. The logic may then retrieve the account information associated with the identified account, and provide the account information to the terminal while masking account information associated with the second account from the terminal.

The capacitive buttons bring the advantage of on-the-fly selection of the payment account/payment application. Specifically, the user does not need to make a payment account/application selection before conducting the transaction. The payment account/application selection is achieved by the cardholder placing their finger on the desired button while presenting the user card to the access device. The LED indicators eliminate the need to have an on-card screen component that would indicate the selected payment account/application. The LED may be electrically coupled to the electronic circuit and the surface feature associated with the LED. The LED may be powered up when the surface feature associated with the LED is activated. The LED uses the same power source as the chip on the user card. For example, the LED may use the power supplied by contact chip pin from the access device or the power harvested from the contactless antenna. Accordingly, embodiments advantageously eliminate the need to have an on-card battery or recharge the on-card battery.

According to various embodiments, the LED indicator can be integrated into the sensory area, for example, glowing under/around the area, glowing around the printed logo/text (as shown in FIG. 7). The LED indicator can use different color to provide different feedbacks to the cardholder, for example, green means pass, red means fail. The LED indicator can use different patterns to provide different feedbacks to the cardholder, for example, instant on, slow blink, quick blink. In some embodiments, the LED may be powered up when a corresponding surface feature is activated. The LED may emit a first color when a first account is selected and emit a second color when a second account is selected.

According to various embodiments, a variety of design considerations may be taken into account when designing the user card, and placing the surface features thereon. For example, each capacitive button area may be sized and dimensioned to be at least one adult's thumb size. For example, two capacitive buttons may be placed on the user card to be at least one adult's thumb size away to avoid a miss trigger. These and other considerations may be incorporated into the layout of the user card to achieve best of performance of the features described herein.

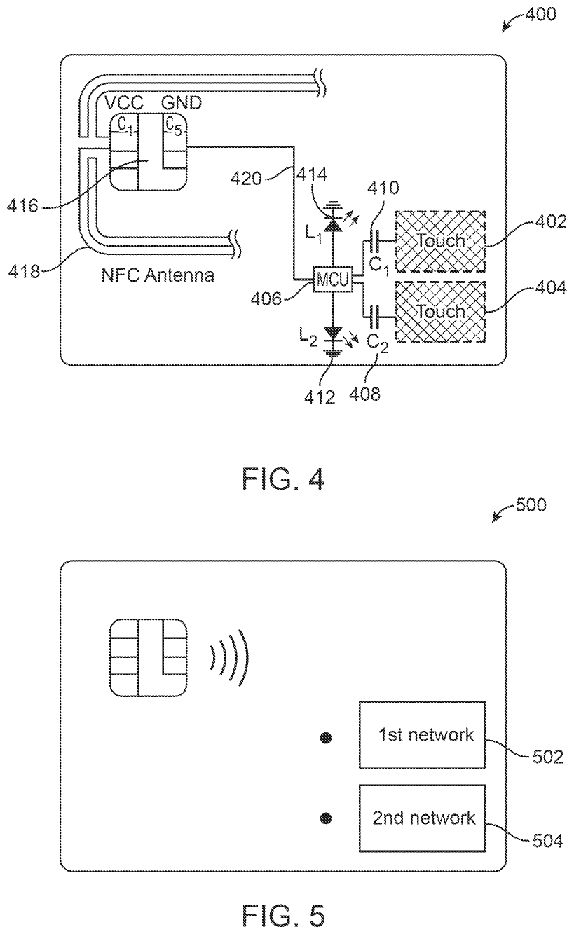

FIG. 4 illustrates an internal circuit of an exemplary user card 400 with multiple surface features 402, 404, according to various embodiments. The user card 400 includes an integrated circuit 416 with a plurality of prongs (e.g., C1 VCC and C5 GND prongs) that provide power to the user card 400 during a contact transaction. The user card 400 also include an NFC antenna 418 that provides power to the user card 400 during a contactless transaction.

The exemplary user card 400 may include a first capacitive button 402 and a second capacitive button 404 that may include touch panels. A microcontroller unit (MCU) 406 may be powered via a wired connection 420 to the integrated circuit 416. The MCU 406 may communicate the input from the capacitive buttons 402, 404 to the integrated circuit 416 for the selection of the associated payment account/application. A first capacitor 410 is provided between the first capacitive button 402 and the MCU 406. A second capacitor 408 is provided between the second capacitive button 404 and the MCU 406. When the first capacitive button 402 is activated, the electrical connection between the first capacitive button 402 and the MCU 406 is completed. That is, the first payment account/application is activated. MCU 406 retrieves the account information associated with the first payment account/application (which is in turn associated with the first capacitive button 402). At this point, the circuit associated with the second capacitive button 404 is broken, no current flows through the second capacitor 408. That is, the second payment account/application is deactivated.

Similarly, when the second capacitive button 404 is activated, the electrical connection between the second capacitive button 404 and the MCU 406 is completed. That is, the second payment account/application is activated. MCU 406 retrieves the account information associated with the second payment account/application (which is in turn associated with the second capacitive button 404). At this point, the circuit associated with the first capacitive button 402 is broken, no current flows through the first capacitor 410. That is, the first payment account/application is deactivated.

The user card 400 further includes a first visual aid (e.g., LED 414) and a second visual aid (e.g., LED 412) associated with the first capacitive button 402, and the second capacitive button 404, respectively. The first LED 414 and the second LED 412 are controlled by the integrated circuit 416 and the MCU 406 based on the input received at the capacitive buttons 402, 404. For example, when the first capacitive button 402 is activated, the first LED 414 is powered/activated. When the second capacitive button 404 is activated, the second LED 412 is powered/activated.

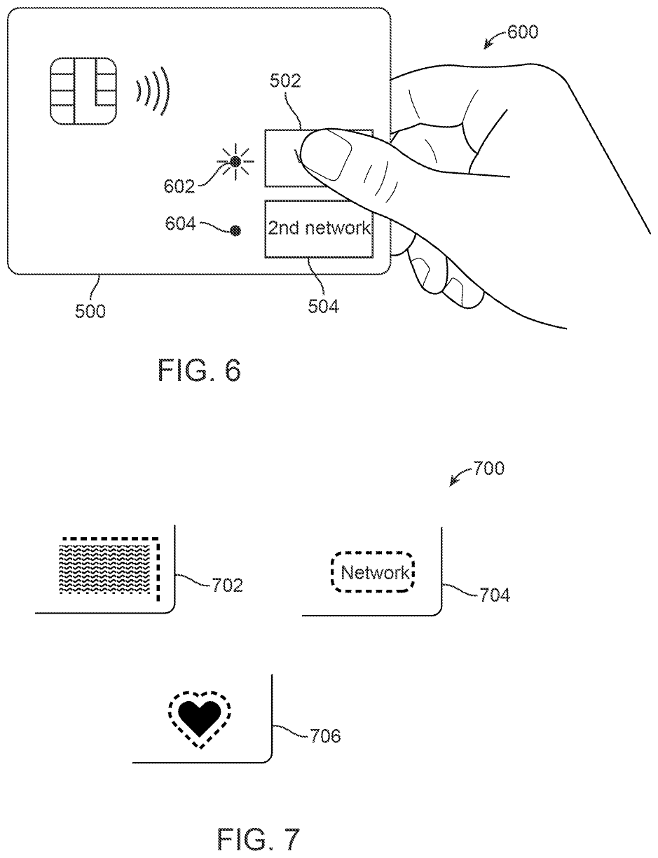

FIGS. 5-6 illustrate the use of an exemplary user card including multiple exposed surface features, according to various embodiments. Specifically, FIG. 5 illustrates an exemplary user card including multiple exposed surface features, according to various embodiments. FIG. 6 illustrates a user selecting an account on an exemplary user card using an exposed surface feature, according to various embodiments. As shown in FIG. 5, the exemplary user card 500 includes a first capacitive button 502 printed with a first application logo (e.g., first transaction processing network (TPN) and a second capacitive button 504 printed with a second application logo (e.g., second transaction processing network (TPN). As shown in FIG. 6, the cardholder 600 can make a user selection by pressing on (e.g. putting a finger on) the first capacitive button 502 printed with a first application logo. The exemplary user card 500 provides feedback to the cardholder 600 by lighting up the first visual aid (e.g., the first LED 602) associated with the first capacitive button 502. The second visual aid (e.g., the second LED 604) associated with the second capacitive button 504 remains inactive. According to various embodiments, the capacitive buttons may be programmable by the logic stored on the user card 500. For example, the programming behaviors can include (1) control the LEDs on/off, flash; (2) change the payment system environment (PSE) and proximity payment system environment (PPSE) content including application identifier (AID) entries and priority indicator; (3) change the selectable or not status AID of the payment applications; (4) change the payment applications' processing restriction behavior (e.g., reject a transaction with error status).

In conventional systems, a conventional contactless chip card interacts with a contactless access device (e.g., POS terminal) as follows: (1) the contactless

POS terminal powers on and ready for transaction; (2) the cardholder presents the contactless card to the POS terminal; (3) the contactless card antenna harvests the energy from the POS terminal antenna and powers on the chip on the card; (4) the chip on the card provides the second application as the higher priority application on the card, and the first application as the lower priority application on the card to POS terminal in PPSE selection response; and (5) when the POS terminal supports both the second application and the first application, the POS terminal always selects the second application to process the transaction.

On the other hand, in an exemplary flow according to various embodiments, a user card as shown and described in FIGS. 1-6 can dynamically change the card content based on the cardholder selection. The exemplary user card 500 according to various embodiments interacts with a contactless access device (e.g., POS terminal) as follows: (1) the contactless POS terminal powers on and ready for transaction; (2) the cardholder presents the contactless co-badged card 500 to the POS terminal and puts his/her finger on the first capacitive button 502 or the second capacitive button 504; (3) the contactless antenna of the co-badged card 500 harvests the energy from the POS terminal antenna and powers on the chip on the co-badged card 500; (4) if the chip detects the first capacitive button 502 is activated, it returns the first payment application. The second payment application is masked from the POS (e.g. the second payment application is disabled). If the chip detects the second capacitive button 504 is activated, it returns the second payment application. The first payment application is masked from the POS (e.g. the first payment application is disabled). If the chip detects none of the capacitive buttons are activated, it returns a default payment application based on, for example, a preprogramed selection or a random selection. (5) The POS processes the transaction with the user-selected payment application; (6) the chip on the co-badged card will light the first LED 602 if the first payment application is selected to process the transaction, the chip on the card will light the second LED 604 if the second payment application is selected to process the transaction.

In some embodiments, the logic on the card may not disable the remaining accounts while transmitting the credentials for the selected account to the access device. For example, the logic may assign a first (higher) priority to the selected account, and may assign a secondary (lower) priority to the remaining accounts. In communicating with the access device, the card logic may present the accounts along with their associated priorities. According to such embodiments, a user card can dynamically change the card content based on cardholder selection as follows: (1) the contactless POS terminal powers on and ready for transaction; (2) the cardholder presents the co-badged card 500 to the POS terminal and puts his/her finger on the first capacitive button 502 or the second capacitive button 504; (3) the antenna of the co-badged card 500 harvests the energy from the POS terminal antenna and powers on the chip on the co-badged card 500. (4) If the chip detects the first capacitive button 502 is activated, it returns the first payment account/application as higher priority (e.g., priority 1) and the second payment account/application as lower priority (e.g., priority 2) in PPSE selection response. If the chip detects the second capacitive button 504 is activated, it returns the second payment account/application as higher priority (e.g., priority 1) and the first payment account/application as lower priority (e.g., priority 2) in PPSE selection response. If chip detects none of the capacitive buttons are activated, it returns one of the payment accounts/applications (e.g., the second payment account/application) as priority 1 and the other payment account/application (e.g., the first payment account/application) as priority 2 in PPSE selection response; (5) the POS selects the first payment account/application or the second payment account/application on the co-badged card 500 to process the transaction. (6) The chip on the co-badged card 500 will light the first LED 602 if the first payment account/application is selected to process the transaction, the chip on the card will light the second LED 604 if the second payment account/application is selected to process the transaction. In such embodiments, the co-badged card 500 may not appear as a single-application card to the POS terminal when in communication with the POS terminal.

According to various embodiments, the capacitive button 502, 504 may be used to turn on NFC capabilities of the co-badged card 500 to protect the privacy of cardholder and to prevent NFC pick-pocketing. For example, when there is no finger touch detected on the capacitive buttons 502, 504, the payment application(s) associated with the capacitive buttons 502, 504 may not be selected and/or read by a NFC reading device. For example, when the co-badged card 500 is provided on a wallet or pocket of the cardholder, the co-badged card 500 cannot be read by someone approaching the cardholder with a NFC reader in a crowded environment like public transportation. When the cardholder wants to use the co-badged card 500 during a transaction, the cardholder must activate the payment account/application by placing his/her finger on one of the capacitive buttons 502, 504 to allow the corresponding payment account/application to be provided to a terminal. This functionality may not be exclusive to the co-badged card. The same functionality may be provided on user cards that store account information associated with only one account. Preventing the account information from being read unless the user card is activated by the user placing their finger on a touch area of the card would prevent NFC pick-pocketing of the single-account card as well.

FIG. 7 illustrates various ways a visual aid may be coupled to exposed surface features of a user card, according to various embodiments. For example, the LED indicator can be integrated into the sensory area 702, for example, glowing under/around the area, glowing around the printed text 704, or glowing around the printed logo 706. These examples are provided for illustrative purposes and should not be construed as limiting. One of ordinary skill in the area will recognize that the LED indicator may be provided in many alternative ways. As provided above, the LED indicator can use different colors or patterns to provide different feedbacks to the cardholder.

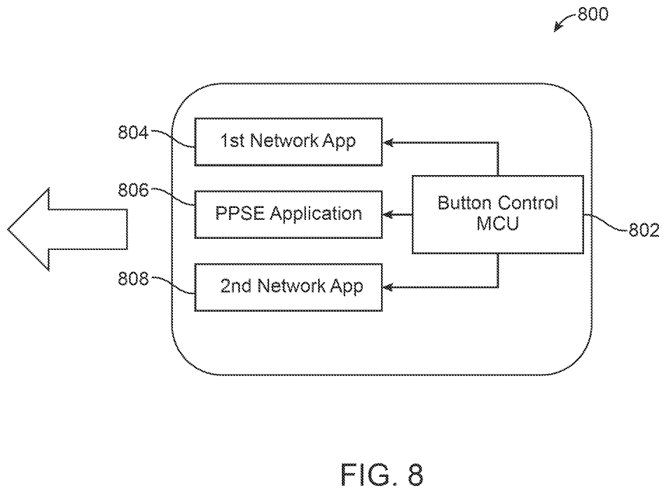

FIG. 8 illustrates multiple user-selectable payment applications stored on a user card, according to various embodiments. The exemplary co-badged card 800 may include a first network payment application 804, a selection application (e.g., PPSE application) 806, and a second network payment application 806. The PPSE application 806 on a contactless card contains the list of all card applications supported by the contactless interface, and is returned from the card in response to the reader issuing a “select” command for the PPSE application. For example, the first network payment application 804 and the second network payment application 806 may comply with existing EMV standards (contact and contactless). Accordingly, the application internal logic and external communication protocol to the merchant terminal may not need modification. Accordingly, the incorporation of the features described herein into the co-badged cards may not have impact to the existing issuance infrastructure.

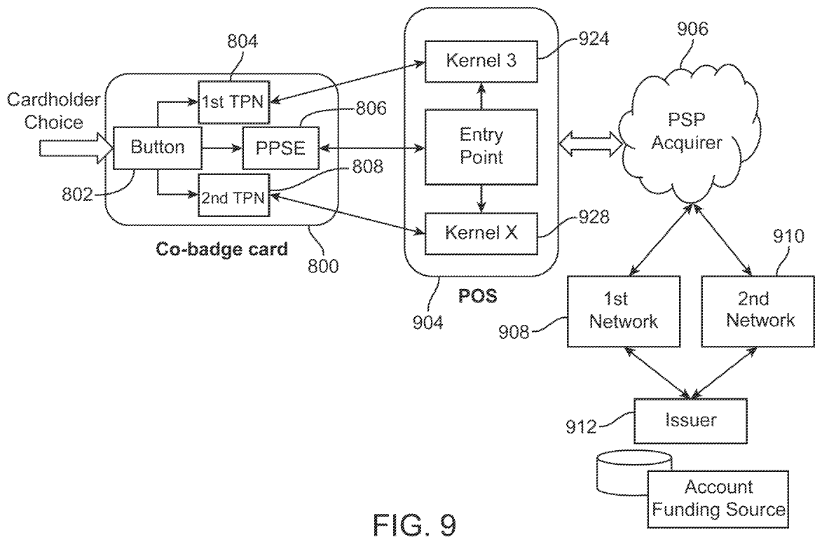

FIG. 9 illustrates initiation and processing of a transaction using a co-badged card 800 (illustrated in FIG. 8) storing multiple user-selectable payment applications, according to various embodiments. Cardholder choice determines whether the first transaction processing network (TPN) application 804 or the second TPN application 808 will be used for next EMV card present transaction. The selection of payment application may be accomplished using a surface feature, (e.g., a button 802), and communicated to a reader (e.g., a terminal) through a selection application (e.g., PPSE application) 806 provided on the co-badged card 800.

Entry Point is the common reader processing that determines the supported applications on a contactless card by analyzing the PPSE application to find the reader combinations (e.g., combination of application identifier and kernel ID that identifies a specific contactless card scheme's application) that are mutually supported by the card and the reader. The kernel may refer to a set of functions that provides all the necessary processing logic and data that is required to perform an EMV contact or contactless transaction.

In FIG. 9, the entry point 924 (e.g., kernel 3) on the POS terminal 904 interacts with the first TPN application 804 on the co-badged card 800. The entry point 928 (e.g., kernel x) on the POS terminal 904 interacts with the second TPN application 808 on the co-badged card 800. The incorporation of the surface features and other techniques described herein in connection with application selection into the co-badged cards has no impact to existing acceptance infrastructure. Depending on which entry point 924, 928 is used to interact with card application chosen by cardholder, the EMV card present transaction can be routed first through the acquirer 906, and then differently through the first application processing network 908 or the second application processing network 910, to get the authorization response from the co-badge card issuer 912. The network messaging and connection does not need modification, thus no impact to existing network infrastructure by the additional application selection capability.

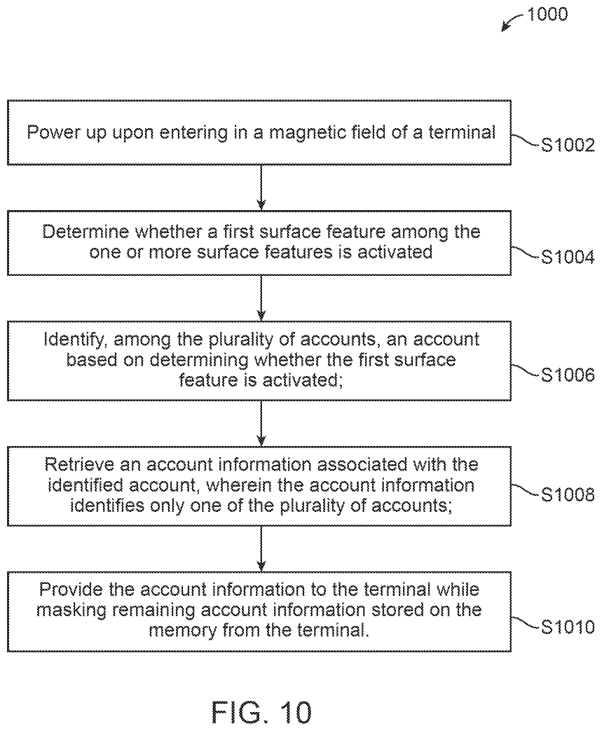

FIG. 10 illustrates a flowchart 1000 of steps, according to various embodiments. The user card is a co-badged card storing multiple accounts/applications on its memory/secure element. The user card comprises a substrate; an electronic circuit embedded on the substrate; an antenna embedded on the substrate; one or more surface features exposed on a surface of the substrate; and a memory embedded on the substrate electrically coupled to the electronic circuit, the antenna, and the one or more surface features, the memory storing account information associated with a plurality of accounts.

At step S1002, the user card is brought in proximity of a terminal (e.g., an access device, a POS terminal). For example, the user card is tapped on or dipped into the terminal. The user card powers up upon entering in a magnetic field of the terminal.

At step S1004, a logic on the user card is programmed to determine whether a first surface feature among the one or more surface features is activated. For example, the user may have placed their fingers on a first surface feature or a second surface feature of the user card. In some embodiments, the user may not place their fingers on any of the touch areas (e.g., surface features) or may be pressing on more than one surface feature (e.g., by mistake, thereby creating a miss trigger).

At step S1006, the logic is programmed to identify, among the plurality of accounts, an account based on determining whether the first surface feature is activated. For example, a first account may be associated with the first surface feature, and a second account may be associated with the second surface feature. If the first surface feature is activated, the logic may be programmed to identify the first account as the selected account. If the second surface feature is activated, the logic may be programmed to identify the second account as the selected account. If no surface feature is activated or more than one surface feature is activated, the logic may be programmed to identify a default account (e.g., a predetermined default account, or a randomly selected default account). Alternatively, when no surface feature is activated, or more than one surface feature is activated, the logic may be programmed to stop further processing (e.g., no account information will be provided to the terminal).

At step S1008, the logic is programmed to retrieve an account information associated with the identified account, wherein the account information identifies only one of the plurality of accounts.

At step S1010, the logic is programmed to provide the account information to the terminal while masking remaining account information stored on the memory from the terminal. In some embodiments, the logic may be programmed to assign a first (higher) priority to the identified account, and may assign a secondary (lower) priority to the remaining accounts. In communicating with the access device, the card logic may present the accounts along with their associated priorities.

If the one or more surface features include a fingerprint sensor, then the logic may be further programmed to acquire a first fingerprint information. The identified account is associated with the first fingerprint information. Another account among the plurality of accounts is associated with a second fingerprint information. If the one or more surface features include a first capacitive button associated with a first account and a second capacitive button associated with a second account, then the logic may further be programmed to: determine that the first capacitive button is activated by being pressed upon; identify, among the plurality of accounts, the first account as the identified account based on determining that the first capacitive button is activated; retrieve the account information associated with the identified account; and provide the account information to the terminal while masking account information associated with the second account from the terminal.

Embodiments provide many technical advantages. Embodiments provide a chip card that stores multiple user-selectable applications (e.g., payment applications, payment accounts, or other accounts). Once the user selects one of the accounts stored on the card, the card masks/deactivates the remaining accounts on the card. Therefore, the multi-application card appears as a single-application card (e.g., a card storing only the user-selected application) to a terminal during a transaction. The user can select the application without having to interact with the terminal by, for example, touching the terminal surface that is touched by multiple people throughout the day. In addition, embodiments allow the user to select a card prior to interacting with the terminal, thereby prior to providing available accounts information to the terminal. The EMV card present transaction routing choice by cardholder through different payment networks capability helps co-badge card issuer to comply with local market regulation (anti-monopoly, fair-market competition), giving payment network and PSP and acquirer flexible business models. All these advantages are achieved without impacting the issuance, acceptance and network infrastructure.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

The above description is illustrative and is not restrictive. Many variations will become apparent to those skilled in the art upon review of the disclosure. The scope should, therefore, be determined not with reference to the above description, but instead should be determined with reference to the pending claims along with their full scope or equivalents.

One or more features from any embodiment may be combined with one or more features of any other embodiment without departing from the scope.

As used herein, the use of “a,” “an,” or “the” is intended to mean “at least one,” unless specifically indicated to the contrary.

What is claimed is:

1. A user card comprising:
a substrate;
an electronic circuit embedded on the substrate;
an antenna embedded on the substrate;
one or more surface features exposed on a surface of the substrate; and
a memory embedded on the substrate electrically coupled to the electronic circuit, the antenna, and the one or more surface features, the memory storing:
account information associated with a plurality of accounts; and
a logic programmed to:
power up upon entering in a magnetic field of a terminal;
determine whether a first surface feature among the one or more surface features is activated;
identify, among the plurality of accounts, an account based on determining whether the first surface feature is activated;
retrieve an account information associated with the identified account, wherein the account information identifies only one of the plurality of accounts; and
provide the account information to the terminal.

2. The user card of claim 1, wherein the one or more surface features include a fingerprint sensor, wherein the logic is further programmed to:
acquire a first fingerprint information, wherein the identified account is associated with the first fingerprint information, wherein another account among the plurality of accounts is associated with a second fingerprint information.

3. The user card of claim 1, wherein the logic is further programmed to:
determine that none of the one or more surface features is activated, wherein the identified account is a default account.

4. The user card of claim 1, wherein the one or more surface features include a capacitive button associated with a first account among the plurality of accounts, wherein the logic is further programmed to:
determine that the capacitive button is activated by being pressed upon; and
identify, among the plurality of accounts, the first account as the identified account based on determining that the capacitive button is activated.

5. The user card of claim 1, wherein the one or more surface features include a first capacitive button associated with a first account and a second capacitive button associated with a second account, wherein the logic is further programmed to:
determine that the first capacitive button is activated by being pressed upon;
identify, among the plurality of accounts, the first account as the identified account based on determining that the first capacitive button is activated;
retrieve the account information associated with the identified account; 9 and
provide the account information to the terminal while masking account 11 information associated with the second account from the terminal.

6. The user card of claim 1, wherein the user card includes a payment card, and the account information includes payment credentials.

7. The user card of claim 1, further comprising:
one or more visual aids exposed on the surface of the substrate, wherein at least one of the one or more visual aids is activated when one of the one or more surface features are activated.

8. The user card of claim 7, wherein each one of the one or more visual aids is associated with one of the one or more surface features, wherein a visual aid is provided in proximity of or below the surface feature associated with the visual aid.

9. The user card of claim 7, wherein the one or more visual aids includes at least one light emitting diode (LED).

10. The user card of claim 9, wherein the LED emits a first color when a first account is selected as the identified account and a second color when a second account is selected as the identified account.

11. The user card of claim 7, wherein the one or more visual aids includes a light emitting diode (LED) per each one of the one or more surface features, wherein the LED is powered up when a corresponding surface feature is activated.

12. The user card of claim 1, wherein the account information is provided to the terminal using a near field communication capability of the user card.

13. A method of manufacturing a user card comprising:
providing a substrate;
embedding an electronic circuit on the substrate;
embedding an antenna on the substrate;
forming one or more surface features exposed on a surface of the substrate;
embedding a memory on the substrate;
electrically coupling the memory, the electronic circuit, the antenna, and the one or more surface features;
storing account information associated with a plurality of accounts on the memory; and
storing a logic on the memory, wherein the logic is programmed to:
power up upon entering in a magnetic field of a terminal;
determine whether a first surface feature among the one or more surface features is activated;
identify, among the plurality of accounts, an account based on determining whether the first surface feature is activated;
retrieve an account information associated with the identified account, wherein the account information identifies only one of the plurality of accounts; and
provide the account information to the terminal.

14. The method of claim 13, wherein the one or more surface features include a fingerprint sensor, wherein the logic is further programmed to:
acquire a first fingerprint information, wherein the identified account is associated with the first fingerprint information, wherein another account among the plurality of accounts is associated with a second fingerprint information.

15. The method of claim 13, wherein the one or more surface features include a capacitive button associated with a first account among the plurality of accounts, wherein the logic is further programmed to:
determine that the capacitive button is activated by being pressed upon; and
identify, among the plurality of accounts, the first account as the identified account based on determining that the capacitive button is activated.

16. The method of claim 13, further comprising:
providing one or more light emitting diodes (LEDs) on the surface of the substrate, wherein each one of the one or more LEDs is associated with one of the one or more surface features, wherein a LED is provided in proximity of or below the surface feature associated with the LED; and
electrically coupling the LED to the electronic circuit and the surface feature associated with the LED, wherein the LED is powered up when the surface feature is activated.

17. A method comprising:
powering up, by a logic stored on a memory of a user card, upon entering in a magnetic field of a terminal, wherein account information associated with a plurality of accounts are stored on the memory;
determining, by the logic stored on the memory of the user card, whether a first surface feature among one or more surface features exposed on a surface of the user card is activated;
identifying, among the plurality of accounts, an account based on determining whether the first surface feature is activated;
retrieving an account information associated with the identified account, wherein the account information identifies only one of the plurality of accounts; and
providing the account information to the terminal.

18. The method of claim 17, wherein the one or more surface features include a fingerprint sensor, the method further comprising:
acquiring a first fingerprint information, wherein the identified account is associated with the first fingerprint information, wherein another account among the plurality of accounts is associated with a second fingerprint information.

19. The method of claim 17, wherein the one or more surface features include a capacitive button associated with a first account among the plurality of accounts, the method further comprising:
determining that the capacitive button is activated by being pressed upon; and
identifying, among the plurality of accounts, the first account as the identified account based on determining that the capacitive button is activated.

20. The method of claim 17, wherein one or more light emitting diodes (LEDs) are provided on the surface of the user card, wherein each one of the one or more LEDs is associated with one of the one or more surface features, wherein a LED is provided in proximity of or below the surface feature associated with the LED; the method further comprising:
powering up the LED when the surface feature is activated.
